(19) United States
(12) Patent Application Publication
(10) Pub. No.: US 2025/0296131 A1
(43) Pub. Date: Sep. 25, 2025

(54) METHOD OF TREATING BATTERY-DERIVED MIXTURE AND METHOD OF TREATING BATTERY

(71) Applicants: HONDA MOTOR CO., LTD., Tokyo (JP); WEF Institute of Technology Inc., Shiga (JP)

(72) Inventors: Takayuki Sakata, Wako-shi (JP); Mitsumasa Sorazawa, Wako-shi (JP); Yushi Fujinaga, Wako-shi (JP); Satoru Takahashi, Wako-shi (JP); Akira Aoyama, Shiga (JP)

(21) Appl. No.: 19/079,758

(22) Filed: Mar. 14, 2025

(30) Foreign Application Priority Data
Mar. 21, 2024 (JP) 2024-044928

(51) Int. Cl. B09B 3/80; B09B 3/40; B09B 101/16; H01M 10/54

(52) U.S. Cl. CPC B09B 3/80; B09B 3/40; B09B 2101/16; H01M 10/54

(57) ABSTRACT

Provided is a method of treating a battery-derived mixture, which is a mixture containing a positive electrode material of a battery containing any one or more of nickel, cobalt, and manganese, and an organic substance, the method including: placing the battery-derived mixture in a treatment environment adjusted to a predetermined temperature and predetermined humidity; supplying reactive oxygen species to the treatment environment, thereby causing the reactive oxygen species to react with water present in the treatment environment to generate a hydroxyl radical; and decomposing the organic substance by the generated hydroxyl radical.

### INCORPORATION BY REFERENCE

The present application claims priority under 35 U.S.C. § 119 to Japanese Patent Application No. 2024-044928 filed on Mar. 21, 2024. The content of the application is incorporated herein by reference in its entirety.

### BACKGROUND OF THE INVENTION

### Field of the Invention

The present invention relates to a method of treating a battery-derived mixture and a method of treating a battery.

### Description of the Related Art

In recent years, research and development have been conducted on recycling of secondary batteries, which contribute to energy efficiency, in order to ensure that more people have access to affordable, reliable, sustainable, and advanced energy. For example, some of lithium ion batteries and solid-state batteries include a laminated electrode in which a positive electrode plate and a negative electrode plate are laminated with a separator interposed therebetween. The positive electrode of these batteries uses a ternary positive electrode material (NCM) containing nickel, cobalt, and manganese. Therefore, methods have been proposed for recovering valuable metals such as NCM from used secondary batteries.

In order to recover the valuable metals from the batteries, it is necessary to separate a positive electrode active material containing the valuable metals from a positive electrode structure. As a method of achieving this, a technique has been proposed for removing a binder that fixes a positive electrode active material. For example, an apparatus is disclosed in Japanese Translation of PCT International Application Publication No. 2023-521735 that recovers a positive electrode active material from an electrode scrap of a used battery. According to the apparatus disclosed in Japanese Translation of PCT International Application Publication No. 2023-521735, the electrode scrap containing the positive electrode active material is subjected to a high-temperature heat treatment to remove the binder contained in a positive electrode structure, and the positive electrode active material is separated from a current collector. A method is disclosed in Japanese Translation of PCT International Application Publication No. 2023-521735 in which the binder is dissolved with a solvent to recover the positive electrode active material.

However, according to the method of removing the binder with the solvent, much energy is required to treat the solvent after use, and thus an environmental burden may high. In such a method, it is necessary to select an appropriate solvent depending on the type of binder, which may cause a problem from the viewpoint of practicality. In the method of removing the binder by heat treatment, a material form (crystal structure, etc.) of valuable metals to be recovered is inevitably changed. For this reason, a treatment for reducing the recovered metal oxide may be required to reuse the recovered valuable metal as a positive electrode active material. Thus, a method of efficiently removing the binder is required to recover materials used in the positive electrode of the battery.

In order to solve the above-described problems, the present invention is to efficiently remove the binder used in the positive electrode in order to recover positive electrode materials containing valuable metals from the used secondary battery. Thus, the present invention is to contribute to energy efficiency.

### SUMMARY OF THE INVENTION

An aspect of the present invention provides a method of treating a battery-derived mixture, which is a mixture containing a positive electrode material of a battery containing any one or more of nickel, cobalt, and manganese, and an organic substance, the method including: placing the battery-derived mixture in a treatment environment adjusted to a predetermined temperature and predetermined humidity; supplying reactive oxygen species to the treatment environment, thereby causing the reactive oxygen species to react with water present in the treatment environment to generate a hydroxyl radical; and decomposing the organic substance by the generated hydroxyl radical.

According to an aspect of the present disclosure, it is possible to efficiently remove a binder used in a positive electrode of a battery.

### BRIEF DESCRIPTION OF THE DRAWINGS

FIG. 1 is a diagram illustrating a configuration of a target battery as an example of a target battery to which the present disclosure is applicable;

FIG. 2 is a flowchart illustrating a method of treating a battery; and

FIG. 3 is a diagram illustrating an example of a configuration of a decomposition device.

### DETAILED DESCRIPTION OF THE INVENTION

An embodiment of the present invention will be described below with reference to the drawings.

### 1. Configuration of Target Battery

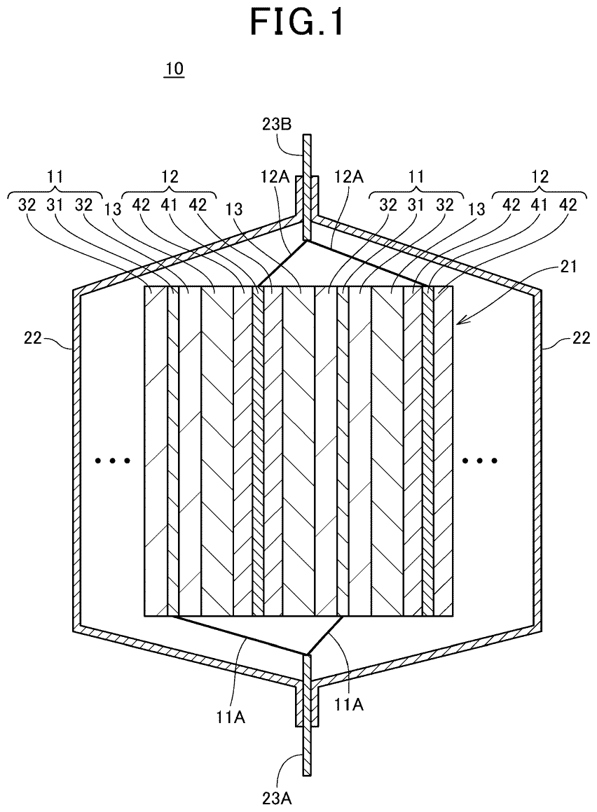

FIG. 1 is a diagram illustrating a configuration of a target battery 10 as an example of a target battery to which the present disclosure is applied, and shows a schematic cross section of the target battery 10. The target battery 10 is a secondary battery capable of charging and discharging. The target battery 10 described in the present embodiment is a laminated battery in which battery materials are enclosed in a laminate material 22, and has a flat plate shape as a whole. The target battery 10 can be referred to as a pouch battery, a laminated battery cell, a pouch battery cell, a lithium ion battery cell, a battery module, or the like.

The target battery 10 is a secondary battery known as a so-called lithium ion battery, and has been attracting attention as a power storage device having a high energy density. Examples of positive electrode active materials for the lithium ion battery may include lithium cobalt oxide, lithium nickel oxide, lithium manganese oxide, and lithium iron phosphate. An example of the positive electrode active material may include a ternary positive electrode material (NCM) containing nickel, cobalt, and manganese. As a negative electrode active material for the lithium ion battery, a carbon-based material is used, for example. a solid-state battery using a solid electrolyte as an electrolyte for the lithium ion battery is known.

Nickel, cobalt, and manganese, which are used as positive electrode active materials in the lithium ion battery and the solid-state battery, are known as valuable metals, and are demanded to be recovered from used batteries. In the present embodiment, a treatment method with excellent efficient is disclosed. In the treatment method disclosed herein, the electrode material to be recovered is a valuable metal contained in the target battery 10, more specifically, a compound related to NCM contained in the positive electrode active material of a positive electrode composite 32. In other words, the electrode material to be recovered is a substance containing any one or more of nickel, cobalt, and manganese.

Hereinafter, a positive electrode material (positive electrode active material) containing any one or more of nickel, cobalt, and manganese will be abbreviated as NCM.

As illustrated in FIG. 1, the target battery 10 has a configuration in which a laminated electrode 21 is housed in the laminate material 22. The laminate material 22 is a laminate film a base material of which is a metal material, for example, an aluminum alloy or stainless steel. The laminate material 22 functions as an outer body of the target battery 10 and as a sealing body for sealing the laminated electrode 21.

The target battery 10 of the present embodiment has a flat plate shape in which two sheets of the laminate material 22 are bonded, and a pair of current collector tabs 23A and 23B for extracting electric power from the target battery 10 penetrate the outer body and are exposed from an end of the target battery 10.

The laminated electrode 21 is a multi-layer body in which positive electrode plates 11 and negative electrode plates 12 are laminated, and a separator 13 is disposed between the positive electrode plate 11 and the negative electrode plate 12. The separator 13 is disposed between the positive electrode plate 11 and the negative electrode plate 12, and prevents a short circuit between the positive electrode plate 11 and the negative electrode plate 12.

The positive electrode plates 11 and the negative electrode plates 12 are disposed alternately, and one positive electrode plate 11 and one negative electrode plate 12 facing each other form one electrode plate pair. A plurality of electrode plate pairs are stacked to form the laminated electrode 21.

The positive electrode plate 11 includes a positive electrode current collector 31 having a rectangular plate shape, and the positive electrode composites 32 are provided on both surfaces of the positive electrode current collector 31. The positive electrode current collector 31 is an aluminum foil or an aluminum plate. The positive electrode composite 32 contains, for example, NCM, a conductive material, a conductive aid, and a binder. The positive electrode plate 11 includes a positive electrode terminal 11A extending from an end of the positive electrode plate 11. Each of the positive electrode terminals 11A extending from the plurality of positive electrode plates 11 forming the laminated electrode 21 is connected to the current collector tab 23A.

The negative electrode plate 12 includes a negative electrode current collector 41 having a rectangular plate shape. A negative electrode composite 42 is provided on a surface of the negative electrode current collector 41 facing the positive electrode plate 11. The negative electrode current collector 41 is made of, for example, copper foil. The negative electrode plate 12 includes a negative electrode terminal 12A extending from an end of the negative electrode plate 12. Each of the negative electrode terminals 12A extending from the plurality of negative electrode plates 12 forming the laminated electrode 21 is connected to the current collector tab 23B.

The current collector tabs 23A and 23B are formed from a thin-plate metal such as copper or aluminum, and pass between the two laminate materials 22 to be exposed outside.

When the target battery 10 is a lithium ion battery, the inside of the laminate materials 22 is filled with a liquid or gel electrolyte solution. The electrolyte solution contains, for example, an electrolyte, a solvent, and an additive. An example of the electrolyte may be a lithium salt such as lithium hexafluorophosphate (LiPF₆). An example of the solvent and the additive may be a carbonate ester such as ethylene carbonate, dimethyl carbonate, diethyl carbonate, or vinylene carbonate. These are merely examples, and the electrolyte, the solvent, and the additive may be selected and changed as appropriate.

When the target battery 10 is a solid-state battery, a solid electrolyte is disposed inside the laminate material 22. Known examples of the solid electrolytes include oxide-based electrolyte and sulfide-based electrolytes, but solid-state batteries using other materials may also be applicable to the present disclosure. The solid electrolyte in the solid-state battery is disposed, for example, between the positive electrode plate 11 and the negative electrode plate 12 in place of the separator 13. In this case, the solid electrolyte also has a function of preventing a short circuit between the positive electrode plate 11 and the negative electrode plate 12 in addition to a function as an electrolyte.

### 2. Method of Treating Battery

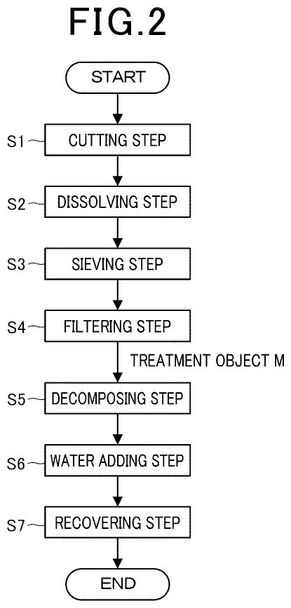

FIG. 2 is a flowchart illustrating a method of treating a battery.

In cutting step S1, a target battery 10 is cut into a plurality of cut pieces. The cut pieces may be a large number of crushed pieces obtained by crushing the target battery 10. In cutting step S1, the laminate material 22 forming the outer body of the target battery 10 is opened, and thus a process of deactivating constituents of the laminate material 22 is performed. The constituents of the laminate material 22 refer to materials that form the laminated electrode 21, and may include the current collector tabs 23A and 23B. The constituents are deactivated when the constituents of the laminate material 22 come into contact with a sufficient amount of water or vapor, for example. Specifically, examples of method of deactivating the constituent may include immersing the cut target battery 10 in water, pouring water on the target battery 10, spraying vapor on the target battery 10, and placing the target battery 10 in an environment where a sufficient amount of water or vapor is present. The water or vapor used for deactivation has preferably a temperature that does not cause changes in a material form (crystal structure, for example) of nickel, cobalt, and manganese contained in the constituents of the target battery 10.

During the process of deactivating the target battery 10, at least a part of lithium contained in the constituents of the target battery 10 is converted into a lithium compound such as lithium hydroxide, which becomes easily soluble in water. In addition, a ventilation process, an intake/exhaust process, a neutralization process, and the like may be performed in response to generation of hydrogen sulfide or other gases during deactivation.

Dissolving step S2 is carried out following cutting step S1. In dissolving step S2, water-soluble constituents contained in the cut pieces cut in cutting step S1 are dissolved in water. In dissolving step S2, for example, by a method of putting or immersing the cut pieces into or in water or a method of washing crushed substances, the crushed substances come into contact with a sufficient amount of water. Accordingly, the water-soluble constituents contained in the constituents of the target battery 10 are eluted in the water. Dissolving step S2 may also serve as a process of deactivating the constituents of the target battery 10 cut up in cutting step S1. In dissolving step S2, the deactivated lithium compound, electrolyte solution, or solid electrolyte is dissolved in water, and thus the water becomes strongly alkaline. By dissolving step S2, the cut pieces become in a state where solid and liquid are mixed.

In sieving step S3, a mixture containing water and crushed substances is sieved to collect solid substances larger than a mesh size of the sieve. Passing substances which have passed through sieves correspond to the mixture obtained in dissolving step S2 from which the relatively large solid substances are removed. The solid substance removed by the sieve is mainly copper foil used for the negative electrode current collector 41, and also includes the aluminum plate, the aluminum foil, fragments of the laminate material 22, and the like used for the positive electrode current collector 31.

From the solid substance collected by the sieve in sieving step S3, copper is recovered in a copper recovering step (not illustrated). Since the remainder after copper recovery contains aluminum and NCM adhering to a surface of the solid substance, the remainder may be combined with the substance passing through the sieve in sieving step S3 and be treated in filtering step S4.

The passing substance in sieving step S3 is filtered in filtering step S4. In filtering step S4, filtration is performed using a filter that is finer than the sieve used in sieving step S3, and solids are collected. The solids collected in filtering step S4 include fine particles, which are, for example, particles including a solid electrolyte, NCM, and a binder, and are a mixture. The solid collected in filtering step S4 is referred to as a treatment object M. The treatment object M corresponds to an example of a “battery-derived mixture” and the “passing substance”.

From liquid passing through the filter in filtering step S4, lithium is recovered in a step (not illustrated). For the recovery of lithium, a known method such as an Li separation method by ionic conductor (LiSMIC) can be used.

The treatment object M collected in filtering step S4 is treated in decomposing step S5. Decomposing step S5 is a step of decomposing organic substances contained in the treatment object M by placing the treatment object M in a treatment environment in which reactive oxygen species are present. The organic substance decomposed in decomposing step S5 is a binder, for example.

The treatment object M to be treated in decomposing step S5 is mixed and stirred with water in water adding step S6 to form slurry containing water, NCM, aluminum, and a trace amount of copper.

In recovering step S7, the NCM is recovered from the slurry. For example, particles of the NCM in the slurry are recovered by magnetism in recovering step S7.

### 3. Details of Decomposing Step po Here, decomposing step S5 will be described in detail.

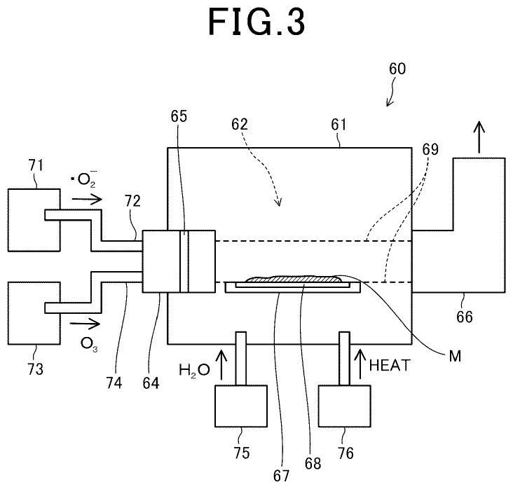

FIG. 3 is a diagram illustrating an example of a configuration of a decomposition device 60. The decomposition device 60 is an example of a device for executing the process of decomposing step S5.

The decomposition device 60 includes a treatment container 61 that houses the treatment object M, and treats the treatment object M housed in the treatment container 61. The decomposition device 60 includes an introduction pipe 64 and an exhaust pipe 66 which are coupled to the treatment container 61. The introduction pipe 64 is a pipe that introduces reactive oxygen species into the inside of the treatment container 61. The treatment object M to be treated in the decomposition device 60 may be in a state of being collected in filtering step S4, or the treatment object M may be in a state where moisture is reduced by dehydration or drying.

A reactive oxygen generator 71 is connected to the introduction pipe 64 through a transport pipe 72, and an ozone generator 73 is connected to the introduction pipe 64 through a transport pipe 74.

The reactive oxygen generator 71 is a device that generates reactive oxygen species having an effect of decomposing organic substances and sends the reactive oxygen species to the transport pipe 72. In the present embodiment, the reactive oxygen generator 71 generates. ·O₂⁻ (superoxide anion radical) as the reactive oxygen species. The reactive oxygen generator 71 uses a first gas as a material for generating the reactive oxygen species. The first gas is a gas containing oxygen molecules (oxygen gas, air, etc.). For example, an oxygen concentrator may be provided along with the reactive oxygen generator 71 to supply oxygen in the air and deliver the first gas containing high-concentration oxygen to the reactive oxygen generator 71.

The reactive oxygen generator 71 includes, for example, an electron emission anion generating unit, an inflow port that allows the first gas to flow in, and an outflow port that allows ionized gas generated by application of a high voltage to flow out. The electron emission anion generating unit includes a cathode needle for applying a high voltage to the first gas, and emits electrons from the needle-shaped cathode needle into the first gas to generate ionized gas. Known electron emission anion generating units can be used for the reactive oxygen generator 71. Examples of these units may include units disclosed in, for example, Japanese Patent Laid-Open No. 7-153549, Japanese Patent Laid-Open No. 10-162932, Japanese Patent Laid-Open No. 10-199654, Japanese Patent Laid-Open No. 10-199655, Japanese Patent Laid-Open No. 10-325560, Japanese Patent Laid-Open No. 2001-338743, Japanese Patent Laid-Open No. 2001-56395, Japanese Patent Laid-Open No. 2002-110312, Japanese Patent Laid-Open No. 2002-319470, Japanese Patent Laid-Open No. 2003-17218, or Japanese Patent Laid-Open No. 2005-5049.

The outflow port of the reactive oxygen generator 71 is connected to the transport pipe 72, and the gas containing the reactive oxygen species generated by the reactive oxygen generator 71 flows into the introduction pipe 64 through the transport pipe 72.

The ozone generator 73 uses a second gas as a material for generating ozone. The second gas is a gas containing oxygen molecules (oxygen gas, air, etc.). For example, an oxygen concentrator may be provided along with the ozone generator 73 to supply oxygen in the air and deliver the second gas containing high-concentration oxygen to the ozone generator 73. The ozone generator 73 includes an inflow port through which the second gas flows in, a discharging device that performs discharging inside the ozone generator 73, and an outflow port that allows a gas containing O₃ (ozone) generated by the discharging to flow out. The discharging device applies a high voltage to a space filled with the second gas to perform silent discharging, thereby generating ozone from oxygen. The outflow port of the ozone generator 73 is connected to the transport pipe 74, and the gas containing the ozone generated by the ozone generator 73 flows into the introduction pipe 64 through the transport pipe 74.

The superoxide anion radicals supplied to the treatment container 61 through the introduction pipe 64 are an example of the “reactive oxygen species”, and the “reactive oxygen species” may include ozone.

The introduction pipe 64 is a hollow pipe through which gas flows, the transport pipe 72 and the transport pipe 74 are connected to one end of the introduction pipe 64, and an internal space of the treatment container 61 communicates with the other end of the introduction pipe 64. A flow velocity adjusting portion 65 is provided inside the introduction pipe 64. The flow velocity adjusting portion 65 is, for example, a plate with a plurality of perforated holes or a flat mesh. The flow velocity adjusting portion 65 reduces a flow velocity of the gas flowing from the transport pipe 72 and the transport pipe 74 into the introduction pipe 64, inside the introduction pipe 64. Thereby, the gas containing the reactive oxygen species generated by the reactive oxygen generator 71 and the gas containing the ozone generated by the ozone generator 73 flow into the inside of the treatment container 61 as a low-speed airflow.

The treatment container 61 is a hollow container, and the inside of the treatment container 61 is a treatment environment 62 for treating the treatment object M. The treatment container 61 is provided with a humidity adjuster 75 for adjusting humidity of the treatment environment 62, and a temperature adjuster 76 for adjusting a temperature of the treatment environment 62.

The humidity adjuster 75 is a device that maintains the humidity of the treatment environment 62 at preset predetermined humidity. The humidity adjuster 75 is a device that supplies, for example, air of high humidity, vapor, mist of water to the inside of the treatment container 61. The humidity adjuster 75 includes a humidity sensor (not illustrated) that detects the humidity of the treatment environment 62, and autonomously adjusts the treatment environment 62 to predetermined humidity based on a value detected by the humidity sensor. The humidity adjuster 75 may be disposed inside the treatment container 61. For example, when the predetermined humidity of the treatment environment 62 is 100%, a container storing water may be disposed in the treatment environment 62, as the humidity adjuster 75.

The temperature adjuster 76 is a device that maintains the temperature of the treatment environment 62 at a preset predetermined temperature. The temperature adjuster 76 is a device that supplies, for example, hot air to the inside of the treatment container 61. The temperature adjuster 76 includes a temperature sensor (not illustrated) that detects the temperature of the treatment environment 62, and autonomously adjusts the treatment environment 62 to a predetermined temperature based on a value detected by the temperature sensor. The temperature adjuster 76 may be installed inside the treatment container 61. For example, the temperature adjuster 76 may include a heater installed inside the treatment environment 62, and may maintain the treatment environment 62 at a predetermined temperature by controlling the power supply and cutoff of the heater. In such a configuration, a blower fan may be installed in the treatment environment 62 together with the heater so as to reduce temperature irregularity.

The treatment environment 62 is an environment in which the predetermined temperature and the predetermined humidity are maintained by the functions of the humidity adjuster 75 and the temperature adjuster 76. More preferably, the treatment environment 62 is an environment in which the predetermined temperature and the predetermined humidity are maintained. In addition, the treatment environment 62 contains a sufficient amount of water molecules (H₂O) supplied by the humidity adjuster 75.

A treatment table 67 is disposed inside the treatment container 61 to hold the treatment object M. The treatment table 67 may be, for example, a plat-like member on which the treatment object M can be mounted, or may be a pillar, a shelf, a leg, or other mechanical structure to hold the container housing the treatment object M inside the treatment container 61.

The treatment table 67 includes a heating unit 68 that heats the treatment object M to a predetermined temperature. The heating unit 68 is, for example, a heater that generates heat with electric power.

The treatment table 67 preferably holds the treatment object M at a position where the treatment object M comes into contact with the airflow flowing in from the introduction pipe 64. In this case, the organic substances of the treatment object M can be effectively decomposed by reactive oxygen species generated by the airflow flowing in from the introduction pipe 64.

For example, as illustrated in FIG. 3, the treatment table 67 may be installed at a position facing an end of the introduction pipe 64. In this case, the airflow flowing from the introduction pipe 64 into the treatment environment 62 quickly reaches the treatment object M, and the surroundings of the treatment object M becomes an atmosphere containing a large amount of reactive oxygen species.

In addition, the treatment container 61 may include a partition wall 69. The partition wall 69 is a plat-like member or a membrane-like member that partitions the surroundings of the treatment table 67 inside the treatment container 61, and surrounds at least the treatment table 67 and the treatment object M on the treatment table 67. In FIG. 3, the partition wall 69 partitions the inside of the treatment container 61 so as to surround the end of the introduction pipe 64. The partition wall 69 is made of a material having air permeability. For example, the partition wall 69 may include holes through which gas flows, or may be made of a nonwoven fabric. In such a configuration, since the reactive oxygen species flowing into the treatment container 61 through the introduction pipe 64 are retained around the treatment object M, the treatment object M can be treated more quickly. Furthermore, since the moisture present in the treatment environment 62 also permeates into the partition wall 69, a reaction involving water molecules can be allowed to proceed sufficiently inside the partition wall 69, as will be described below.

The exhaust pipe 66 is a pipe that allows the inside of the treatment container 61 to communicate with the outside, and discharges exhaust gas from the treatment environment 62. In a configuration in which the decomposition device 60 includes the partition wall 69, the exhaust pipe 66 is disposed to communicate with the inside of the partition wall 69.

The decomposition device 60 may include a control device (not illustrated). In this case, the control device can control the heating unit 68, the reactive oxygen generator 71, the ozone generator 73, the humidity adjuster 75, and the temperature adjuster 76.

In the treatment environment 62, the superoxide anion radicals generated by the reactive oxygen generator 71 react with the ozone generated by the ozone generator 73 and water molecules to generate ·OH (hydroxyl radical) having strong oxidizing power. The reaction is estimated as follows.

First, a superoxide anion radical is generated by a reaction of formula (1) below in the reactive oxygen generator 71.

O₂+e=·O₂⁻ (1)

In the treatment environment 62, the superoxide anion radical reacts with ozone as shown in formula (2) below to generate O₃⁻ (ozonide ion radical).

·O₂⁻+O₃=O₂+·O₃⁻ (2)

The ozonide ion radical reacts with water molecules present in the treatment environment 62 as shown in formula (3) below to generate a hydroxyl radical.

·O₃⁻+H₂O =·OH+O₂+OH⁻ (3)

The hydroxyl radical has high reactivity among the reactive oxygen species and exhibits strong oxidizing power, and thus effectively decomposes the organic substance contained in the treatment object M. The organic substance contained in the treatment object M is a binder and a modified substance derived from the binder. The modified substance is generated by a reaction between a sulfide contained in the electrolyte of the target battery 10 and the binder, for example. The hydroxyl radical has an effect of oxidizing and decomposing C—H bonds, C—C bonds, C—O bonds, C—S bonds, and S—S bonds of the organic substance.

In the treatment environment 62, since the hydroxyl radical is generated around the treatment object M, the organic substance such as the binder contained in the treatment object M is decomposed. In particular, the decomposition device 60 generates a hydroxyl radical from a superoxide anion radical, ozone, and water in the treatment environment 62 in which the treatment object M is disposed. Although the hydroxyl radical has a short life span, since the hydroxyl radical immediately after generation comes into contact with the treatment object M in the treatment environment 62, the organic substance contained in the treatment object M can be effectively decomposed.

Then, when the organic substance contained in the treatment object M is decomposed, the NCM can be peeled off from the aluminum foil used as the positive electrode current collector 31 of the target battery 10. In addition, the positive electrode composite 32 solidified by the binder is decomposed, and thus the NCM can be made removable.

The temperature of the treatment environment 62 is preferably a temperature that does not cause changes in the crystal structure of nickel, cobalt, and manganese contained in the positive electrode composite 32. The same applies to the temperature of the heating unit 68. For example, the temperature of the heating unit 68 is preferably set to 200° C. or lower. The temperature of the treatment environment 62 is lower than the temperature of the heating unit 68.

As described above, the method according to the present embodiment is a method of treating the treatment object M, which is a mixture containing the positive electrode active material of the target battery 10 and the organic substance. In such a treatment method, the treatment object M is disposed in the treatment environment 62 adjusted to the predetermined temperature and the predetermined humidity. Then, the reactive oxygen species are supplied to the treatment environment 62, whereby the water present in the treatment environment 62 reacts with the reactive oxygen species to generate hydroxyl radicals, and the organic substance is decomposed by the generated hydroxyl radicals.

Accordingly, the hydroxyl radicals are generated in the treatment environment 62 adjusted to the predetermined temperature and the predetermined humidity, and the organic substance contained in the treatment object M can be efficiently decomposed. For this reason, the binder of the treatment object M obtained from the used target battery 10 can be efficiently removed, and the positive electrode active material containing valuable metals can be recovered.

The treatment object M is a mixture obtained by decomposing the target battery 10 including the positive electrode composite 32 having a structure in which the positive electrode active material is bonded by a binder, the electrolyte, and the negative electrode composite 42, and the organic substance is the binder.

Accordingly, the binder is removed from the mixture obtained by decomposing the used target battery 10, and thus the positive electrode active material can be recovered more efficiently.

The temperature of the treatment environment 62 is a temperature that does not cause changes in the crystal structure of nickel, cobalt, and manganese contained in the positive electrode active material.

Accordingly, the binder can be removed at a temperature that does not cause changes in the material form (crystal structure, etc.) of nickel, cobalt, and manganese, or oxidation. Therefore, the recovered nickel, cobalt, and manganese can be easily reused as a positive electrode of a battery.

The above-described method of treating the target battery 10 includes sieving step S3 of separating relatively large solid substance from the cut pieces obtained by cutting the constituents of the target battery 10, and decomposing step S5 of using the remainder, from which the solid substance is separated in sieving step S3, as the treatment object M and decomposing the organic substance contained in the treatment object M. The method includes recovering step S7 of recovering the electrode material from the treatment substance treated in decomposing step S5. In decomposing step S5, the treatment object M is placed in the treatment environment 62 adjusted to the predetermined temperature and the predetermined humidity. Then, the reactive oxygen species are supplied to the treatment environment 62, whereby the water present in the treatment environment 62 reacts with the reactive oxygen species to generate hydroxyl radicals, and the organic substance is decomposed by the generated hydroxyl radicals.

Accordingly, the binder can be efficiently removed from the remainder obtained by cutting the used target battery 10 and removing the relatively large solid substance, and the positive electrode material containing valuable metals can be efficiently recovered.

### 4. Other Embodiments

The above-described embodiment is merely one embodiment, and modifications and applications can be arbitrarily made without departing from the scope of the present invention.

An example has been described in the above-described embodiment in which the target battery 10 having the ternary positive electrode material containing nickel, cobalt, and manganese is treated, but the method of treating a battery according to the present disclosure is not limited thereto. The method of treating a battery according to the present disclosure can be applied to a battery using materials containing any one or more of nickel, cobalt, and manganese, without other limitations.

An example has been described in the above-described embodiment in which the decomposition device 60 performs decomposing step S5. The environment for performing decomposing step S5 may be any environment in which the treatment object M is placed in the treatment environment adjusted to the predetermined temperature and the predetermined humidity and the reactive oxygen species can react with water.

Furthermore, the shape of the target battery 10 described in the above-described embodiment is merely an example, and the present disclosure may be applied to a cylindrical or rectangular battery in which a battery material is housed in an outer cover made of iron, aluminum, or the like. In other words, the present disclosure is applicable to a lithium ion battery and a solid-state battery other than the laminated battery.

### 5. Configurations to be Supported by Above-Described Embodiment

The above-described embodiment supports Configurations below.

(Configuration 1) A method of treating a battery-derived mixture, which is a mixture containing a positive electrode material of a battery containing any one or more of nickel, cobalt, and manganese, and an organic substance, the method including: placing the battery-derived mixture in a treatment environment adjusted to a predetermined temperature and predetermined humidity; supplying reactive oxygen species to the treatment environment, thereby causing the reactive oxygen species to react with water present in the treatment environment to generate a hydroxyl radical; and decomposing the organic substance by the generated hydroxyl radical.

According to the method of treating a battery-derived mixture of Configuration 1, the hydroxyl radical is generated in the treatment environment adjusted to the predetermined temperature and the predetermined humidity, and the organic substance contained in the mixture placed in the treatment environment can be efficiently decomposed. For this reason, the binder can be efficiently removed from the mixture obtained from the used battery, and the positive electrode material containing valuable metals can be recovered.

(Configuration 2) The method of treating a battery-derived mixture according to Configuration 1, in which the battery-derived mixture is a mixture obtained by decomposing a battery including a positive electrode having a configuration in which the positive electrode material is bonded with a binder, an electrolyte, and a negative electrode, the organic substance being the binder.

According to the method of treating a battery-derived mixture of Configuration 2, the binder is removed from the mixture obtained by decomposing the used battery, and thus the positive electrode material can be recovered more efficiently.

(Configuration 3) The method of treating a battery-derived mixture according to Configuration 1 or 2, in which the treatment environment has a temperature that does not cause a change in a crystal structure of the nickel, the cobalt, and the manganese contained in the positive electrode material.

According to the method of treating a battery-derived mixture of Configuration 3, the binder can be removed at the temperature that does not cause a change in the material form (crystal structure, etc.) of the nickel, the cobalt, and the manganese contained in the positive electrode material, or oxidation. Therefore, the recovered nickel, cobalt, and manganese can be easily reused as a positive electrode of the battery.

(Configuration 4) A method of treating a battery using, as a target battery, a lithium ion battery or a solid-state battery having an electrode material containing any one or more of nickel, cobalt, and manganese, the method including: a sieving step of separating a relatively large solid substance from cut pieces obtained by cutting constituents of the target battery; a decomposing step of using a remainder, from which the solid substance is separated in the sieving step, as a treatment object and decomposing an organic substance contained in the treatment object; and a recovering step of recovering the electrode material from a treatment substance treated in the decomposing step, the decomposing step including placing the treatment object in a treatment environment adjusted to a predetermined temperature and predetermined humidity, supplying reactive oxygen species to the treatment environment, thereby causing the reactive oxygen species to react with water present in the treatment environment to generate a hydroxyl radical, and decomposing the organic substance by the generated hydroxyl radical.

According to the method of treating a battery of Configuration 4, the hydroxyl radical is generated in the treatment environment adjusted to the predetermined temperature and the predetermined humidity, and the organic substance contained in the mixture placed in the treatment environment can be efficiently decomposed. For this reason, the binder can be efficiently removed from the mixture obtained from the used battery, and the positive electrode material containing valuable metals can be recovered.

### REFERENCE SIGNS LIST

10 . . . target battery; 11 . . . positive electrode plate; 12 . . . negative electrode plate; 13 . . . separator; 21 . . . laminated electrode; 22 . . . laminate material; 32 . . . positive electrode composite; 42 . . . negative electrode composite; 60 . . . decomposition device; 61 . . . treatment container; 62 . . . treatment environment; 64 . . . introduction pipe; 65 . . . flow velocity adjusting portion; 66 . . . exhaust pipe; 67 . . . treatment table; 68 . . . heating unit; 69 . . . partition wall; 71 . . . reactive oxygen generator; 72, 74 . . . transport pipe; 73 . . . ozone generator; 75 . . . humidity adjuster; 76 . . . temperature adjuster; m . . . treatment object.

1. A method of treating a battery-derived mixture, which is a mixture containing a positive electrode material of a battery containing any one or more of nickel, cobalt, and manganese, and an organic substance, the method comprising:
placing the battery-derived mixture in a treatment environment adjusted to a predetermined temperature and predetermined humidity;
supplying reactive oxygen species to the treatment environment, thereby causing the reactive oxygen species to react with water present in the treatment environment to generate a hydroxyl radical; and
decomposing the organic substance by the generated hydroxyl radical.

2. The method of treating a battery-derived mixture according to claim 1, wherein
the battery-derived mixture is a mixture obtained by decomposing a battery including a positive electrode having a configuration in which the positive electrode material is bonded with a binder, an electrolyte, and a negative electrode, the organic substance being the binder.

3. The method of treating a battery-derived mixture according to claim 1, wherein
the treatment environment has a temperature that does not cause a change in a crystal structure of the nickel, the cobalt, and the manganese contained in the positive electrode material.

4. A method of treating a battery using, as a target battery, a lithium ion battery or a solid-state battery having an electrode material containing any one or more of nickel, cobalt, and manganese, the method comprising:
a sieving step of separating a relatively large solid substance from cut pieces obtained by cutting constituents of the target battery;
a decomposing step of using a remainder, from which the solid substance is separated in the sieving step, as a treatment object and decomposing an organic substance contained in the treatment object; and
a recovering step of recovering the electrode material from a treatment substance treated in the decomposing step,
the decomposing step including
placing the treatment object in a treatment environment adjusted to a predetermined temperature and predetermined humidity,
supplying reactive oxygen species to the treatment environment, thereby causing the reactive oxygen species to react with water present in the treatment environment to generate a hydroxyl radical, and
decomposing the organic substance by the generated hydroxyl radical.
